(19) United States
(12) Patent Application Publication
(10) Pub. No.: US 2023/0030875 A1
(43) Pub. Date: Feb. 2, 2023

(54) PHOTODETECTOR BEHAVIOR MODELING

(71) Applicant: Hewlett Packard Enterprise Development LP, Houston, TX (US)

(72) Inventors: Jinsung Youn, Milpitas, CA (US); Peng Sun, Milpitas, CA (US); Mudit Jain, Milpitas, CA (US)

(21) Appl. No.: 17/443,862

(22) Filed: Jul. 28, 2021

(51) Int. Cl. G01J 1/44; G06F 30/20; G06F 1/03

(52) U.S. Cl. CPC G01J 1/44; G06F 30/20; G06F 1/03; G01J 2001/444; G06F 2119/06

(57) ABSTRACT

Examples disclosed herein relate to photodetector (PD) behavior modeling for process design kit. In some examples, a photodetector behavior model may receive input optical data. Further, the photodetector behavior model may be provided with input values corresponding to input parameters. The photodetector behavior model may identify a set of coefficients from a set of coefficient lookup tables, based on the input values corresponding to input parameters. The photodetector behavior model determines characteristics of one or more model parameters of the photodetector based on the identified set of coefficients. The behavior model determines an output metric indicative of an electrical response of the photodetector, based on the input optical data and the determined characteristics of the one or more model parameters.

### BACKGROUND

Silicon photonics comprises the integration of semiconductor photonic devices with silicon electronics on a single platform. Optical interconnects have been actively investigated and deployed for high-performance computing applications. Silicon photonics are commonly used in optical interconnect applications. For example, photodetectors may be co-packaged with electronic circuitry. Accordingly, hardware design tools may include tools for co-simulation of photodetectors and electronic circuitry. For example, a process design kit (PDK) may include models for various photodetectors to run co-simulation with electronic circuitry.

### BRIEF DESCRIPTION OF THE DRAWINGS

The present disclosure, in accordance with one or more various examples, is described in detail with reference to the following figures. The figures are provided for purposes of illustration only and merely depict examples, wherein:

FIG. 1 illustrates an example photodetector behavior model, per the present subject matter;

FIG. 2 illustrates an example set of coefficient lookup tables, per the present subject matter:

FIG. 3A illustrates an example schematic block diagram of a photodetector behavior model, per the present subject matter;

FIG. 3B illustrates an example flow diagram for simulating an electrical response of a photodetector using a photodetector behavior model, per the present subject matter.

FIG. 3C illustrates an example graph of responsivity of photodetector as a function of optical power, for various bias voltages, per the present subject matter.

FIG. 4 illustrates an example of a coefficient lookup table and a set of secondary lookup tables, per the present subject matter;

FIG. 5 is an example flow chart illustrating a method of operation of a photodetector behavior model, with a greater level of detail, per the present subject matter; and

FIG. 6 depicts a schematic block diagram of an example photodetector behavior model in which various examples described herein may be implemented.

The figures are not exhaustive and do not limit the present disclosure to the precise form disclosed.

### DETAILED DESCRIPTION

Photodetectors, such as Silicon photodiodes, are responsive to photons to generate a flow of current. Photodetectors are characterized based on performance metrics such as responsivity, multiplication factor, etc. Generally, photodetectors are operated in reverse bias and exhibit certain characteristics that are linear. For example, responsivity, which is a measure of output current versus incidental optical energy, may exhibit linear characteristics at lower bias voltages. In some instances, the photodetectors may be operated at a higher reverse bias voltage (e.g., voltages higher than 100V in Silicon) to obtain large output currents. At higher reverse bias voltages, the photodetector may exhibit a current gain effect, such as an avalanche effect seen in avalanche photodiodes. Therefore, photodetector hardware models should cover a wide bias voltage range including avalanche regime with varying photodetector characteristics. However, some models provide limited model characteristics that insufficiently simulate the characteristics of photodetectors at actual operational ranges. For example, the limited models may exhibit linear responsivity or multiplication factor, while actual photodetectors may exhibit non-linear behavior, especially when operated at higher bias voltages or in the avalanche regime. Thus, PDKs using such models may provide inaccurate simulation results. Accordingly, users may have to spend considerable time debugging any design issues that may arise due to inconsistency between simulation characteristics and real-time characteristics.

The present disclosure provides techniques for photodetector behavior modeling. This may enable PDKs to include photodetector models with parameters more accurately approximating the manufactured device. The parameters may include responsivity and multiplication factor, as examples. PDK users may verify the photodetector behavior at various operating conditions and run co-simulation with electronic circuitry for different process types and temperature conditions. By more accurately simulating the photodetectors, debugging related to inaccurate model parameters may be reduced or eliminated. Thus, these techniques may allow optimization of a silicon photonics design with reliable verification.

The photodetector behavior model may include a library of coefficient lookup tables (CLTs). Each CLT may include coefficient sets that correspond to bias voltages, process types, and temperature conditions. Based on mandatory or optional input parameters such as operational reverse bias voltage, a set of coefficients is identified from the set of CLTs. Based on the identified set of coefficients, characteristic behaviors corresponding to one or more model parameters are determined. The photodetector model may be configured to exhibit either linear or non-linear behavior in response to a bias voltage. In one example, the characteristics may be determined by selecting a polynomial, logarithmic, or exponential response simulation. Using the equation, linear or non-linear characteristics of model parameters may be determined. The determined characteristics and input optical data may be used to provide an output metric indicative of electrical response of the photodetector.

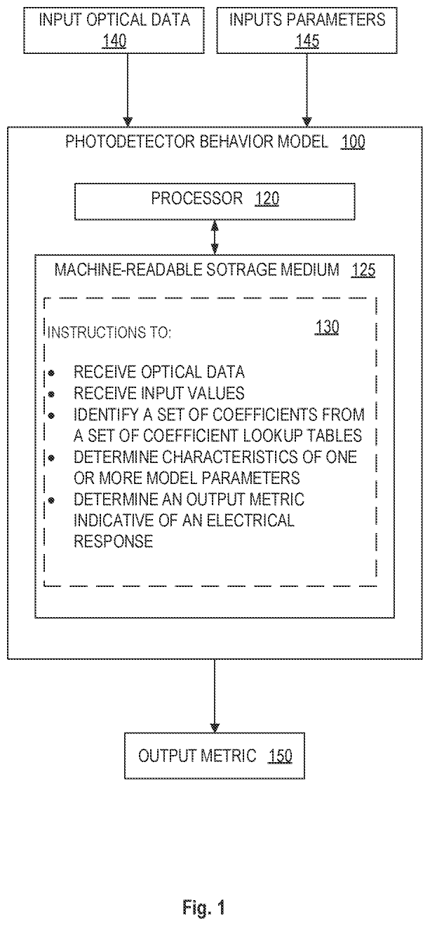

FIG. 1 illustrates an example photodetector behavior model 100. The photodetector behavior model 100 comprises a processor 120 and a machine-readable storage medium 125 coupled to the processor 120. The machine-readable storage medium includes instructions 130 executable by the processor 120 to cause one or more actions, including automatically simulating output metric 150 based on inputs received.

In some examples, instructions 130 may include instructions to receive input optical data 140. The instructions 130 also include instructions to receive inputs values corresponding to input parameters 145. In some examples, the input parameters 145 include a reverse bias voltage, a process type, and/or temperature condition. One or more input parameters 145 may include at least one mandatory input. In some instances, a reverse bias voltage may be categorized as one of the mandatory inputs. Further, input parameters such as a process type and/or a temperature condition may be categorized as optional inputs. Herein, the terms ‘reverse bias voltage’ and ‘bias voltage’ are interchangeably used as the photodetectors are operated in reverse bias in the current context. Herein, the input optical data 140 and the input parameters 145 may be collectively referred to as ‘user inputs.’

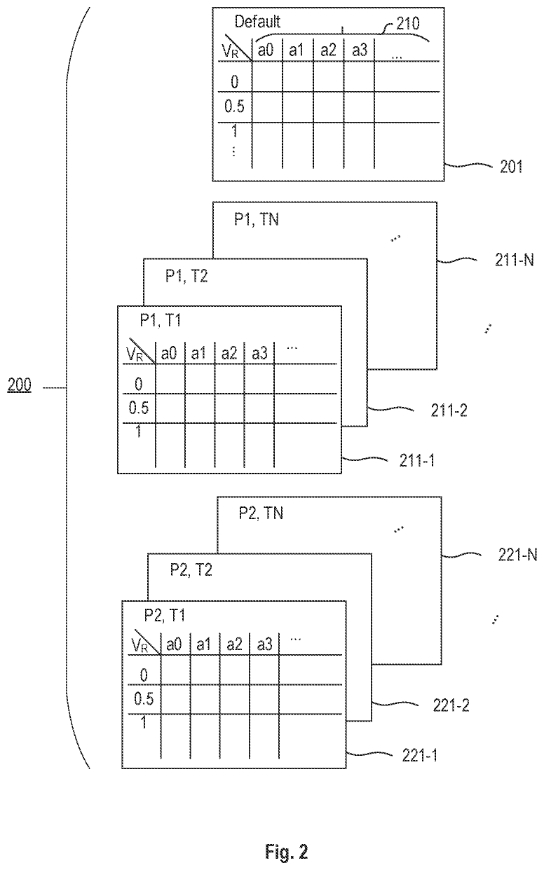

In some examples, based on the one or more input parameters 145 received by the photodetector behavior model 100, the instructions 130 may include instructions to identify a set of coefficients. In some examples, instructions 130 may include instructions to determine characteristics of model parameters of photodetector based on the set of coefficients identified. The set of coefficients corresponds to characteristics of model parameters of the photodetector under simulation. For example, the set of coefficients may determine response characteristics (e.g., linear or non-linear) of the model parameters. In further examples, instructions 130 may include instructions to retrieve the set of coefficients from a set of coefficient lookup tables (CLTs). The set of CLTs is elaborated in FIG. 2. In an example, the set of CLTs may be stored in a storage medium (e.g., storage medium 125). In other example, the set of CLTs may be stored in a storage disk (not shown) disposed external to the photodetector behavior model 100. The storage disk may be connected to the photodetector behavior model 100 by a network that may be wired or wireless.

In some examples, instructions 130 may include instructions to determine an output metric 150 indicative of an electrical response of the photodetector, based on the input optical data 140 and the determined characteristics of the model parameters.

The machine-readable storage medium 125 is a non-transitory type encoded with instructions 130. As used herein, a “machine-readable storage medium” may be any electronic, magnetic, optical, or other physical storage apparatus to contain or store information such as executable instructions, data, and the like. For example, any machine-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

FIG. 2 illustrates an example of a set of CLTs 201, 211-1, 211-2, . . . , 211-N, 221-1, 221-2, . . . , 221-N, which may be collectively referred by ‘200.’ Each CLT in the set of CLTs 200 corresponds to a particular process type and a temperature condition. In various examples, the ‘process type’ refers to a particular semiconductor process corner (e.g., a complementary metal-oxide-semiconductor process corner, which may be a slow corner, a typical corner, or a fast corner) that would be employed to manufacture the simulated photodetector. The temperature condition may include a temperature value/range. For instance, CLT 211-1 may correspond to a process corner P1 and a temperature condition T1.

Each CLT may comprise a plurality of sets of coefficients a0, a1, a2, a3, . . . . For brevity, the set of coefficients are collectively referred by ‘210.’ The set of CLTs 200 may correspond to a combination of a process corner (e.g., P1, and P2) and a temperature condition (e.g., T1, T2, . . . . TN). Further, each CLT comprises a plurality of coefficients corresponding to a plurality of reverse bias voltages. In some examples, each CLT comprises coefficients 210 for various reverse bias voltages (e.g., 0 V, 0.5 V, 1 V, etc.). Voltages may be provided in at least one of random order, a random progressive order, a stepped progressive order, or a combination of one or more thereof based on application or area of use of PDK.

Further, the set of CLTs 200 may include a default CLT 201. As, in some instances, a user may provide only the bias voltage (i.e., mandatory input) and need not provide process type and temperature condition (i.e., optional inputs). In such instances, the default CLT 201 may be selected by the photodetector behavior model for the identification of the set of coefficients. The default CLT 201 may include, for each reverse bias voltage, a set of coefficients, which are based on optimum input parameters. Thus, in some examples, when the photodetector behavior model receives only a reverse bias voltage as user input, the photodetector behavior selects the default CLT. The photodetector behavior model (e.g., model 100 as per FIG. 1) identifies a set of coefficients from a selected CLT.

The identified set of coefficients a0, a1, a2 a3 . . . are used to determine characteristics of one or more model parameters, such as responsivity. For example, at higher bias voltages (e.g., near avalanche breakdown voltages), non-linear characteristics of one or more model parameters may be determined based on the identified set of coefficients. Whereas, in response to receiving a lower voltage value, then linear characteristics of one or more model parameters may be determined based on the corresponding set of coefficients. In further examples, linear or non-linear characteristics may be a function of input optical data. Further, based on the determined model parameters and the input optical data, an output metric of the photodetector behavior model may be determined.

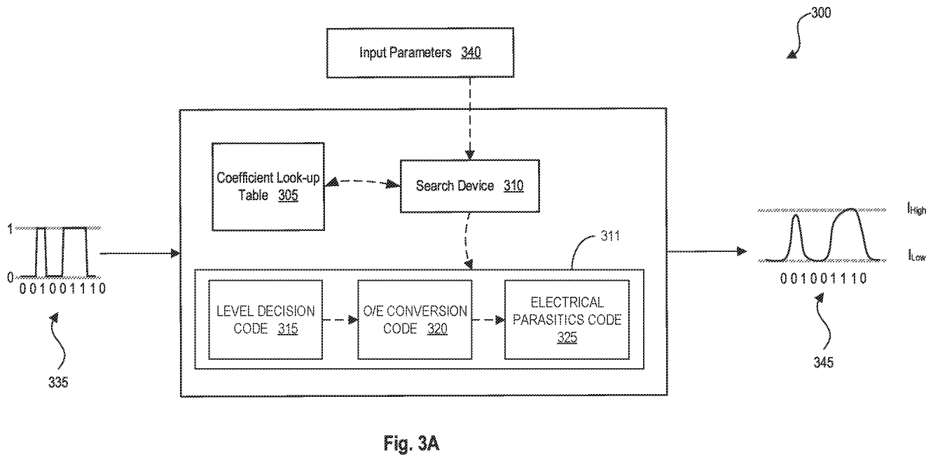

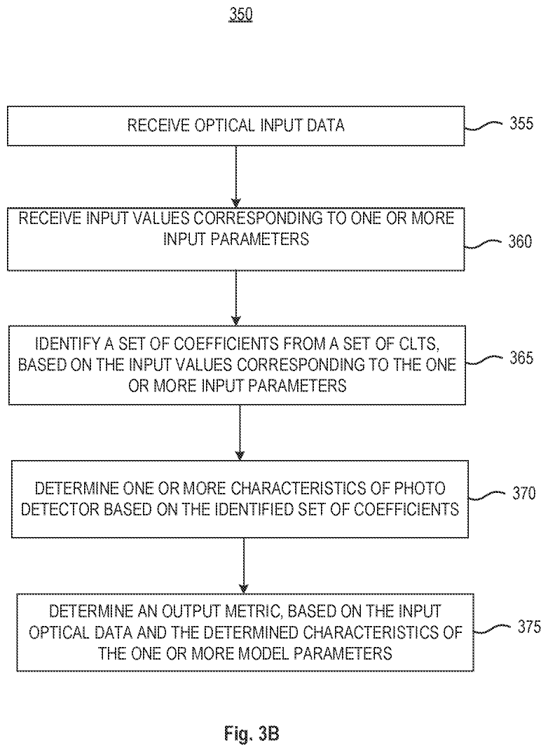

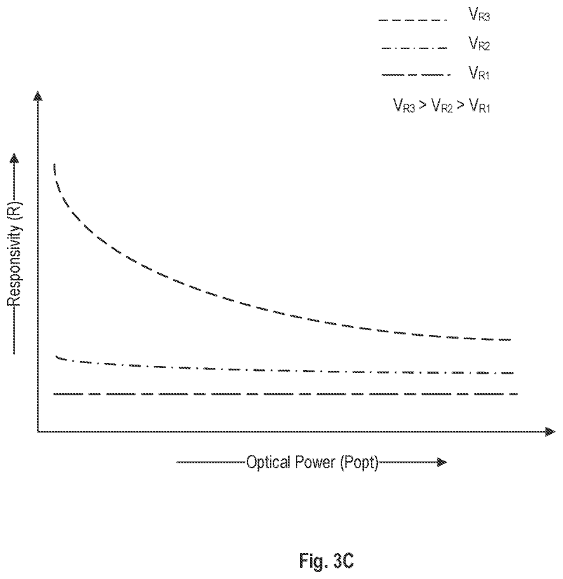

FIG. 3A illustrates an example schematic block diagram of a photodetector behavior model 300. FIG. 3B refers to an example flow diagram 350 for simulating an electrical response of a photodetector using a photodetector behavior model (e.g., model 300). The photodetector behavior model 300 includes a set of coefficient lookup tables (CLTs) 305, a search device 310, and a simulation device 311. In some examples, the simulation device 311 may include a level decision code 315, an optical to electrical (O/E) conversion code 320, and an electrical parasitics code 325. Further, a simulated input optical data 335 is illustrated in the form of binary signals. An output metric 345 comprising a simulated electrical response (e.g., output current varying with a high and low value) is also illustrated in the form of a waveform.

The flow diagram 350 may correspond to a method of operation of a photodetector behavior model 300, as per some examples discussed herein. In further examples, flow diagram 350 may include instructions that are stored in the form of instructions in a machine-readable storage medium. The machine-readable storage medium may be part of the photodetector behavior model 300. The photodetector behavior model 300 may include a processor (e.g., processor 120 of FIG. 1) that may fetch, decode, and execute the instructions to perform one or more actions. In some examples, each of the level decision code 315, the O/E conversion code 320, electrical parasitics code 325 may include additional instructions to perform one or more actions.

In some examples, the set of CLTs 305 is configured to store a plurality of lookup tables storing coefficients, such as CLTs 200 as discussed in FIG. 2. The set of CLTs 305 may be organized based on input parameters such as process corner and/or temperature condition, for efficient identification of coefficients by the photodetector behavior model. The set of coefficients are identified for determining characteristics of one or more model parameters. In some examples, the output metric of the photodetector behavior model may be determined based on the determined model parameters.

The method of operation of photodetector behavior model 300 is discussed in conjunction with method blocks 355-375 of FIG. 3B.

At 355, the photodetector behavior model 300 receives input optical data 355 for a photodetector. For example, a user may be prompted to enter input optical data 355 to the photodetector behavior model 300. At 360, the photodetector behavior model 300 may receive input values corresponding to one or more input parameters 340 corresponding to the photodetector under simulation. In some examples, the received inputs may be fed to a search device 310 to perform one or more actions, i.e., search or identification as discussed herein.

At 365, the photodetector behavior model 300 may identify a set of coefficients from the set of CLTs 305, based on the input parameters 340. In some examples, the search device 310 may search the set of CLTs 305 to identify a set of coefficients corresponding to the input parameters 340. In some instances, the search device 310 may include an automatic search logic/algorithm to search and identify the set of coefficients based on the input parameters 340. For example, where the photodetector behavior model 300 receives a bias voltage (e.g., 1 volt), a process type (e.g., P2), and a temperature condition (e.g., T2), the search device 310 selects a corresponding CLT (say CLT 221-2, as per example of FIG. 2) and identifies a set of coefficients for the received bias voltage.

At 370, the photodetector behavior model 300 may determine characteristics (e.g., linear or non-linear) of one or more model parameters for the photodetector. In some examples, a simulation device 311 may be configured to determine the model parameters for simulation of the electrical response, i.e., output metric 345. In some examples, the simulation device 311 may be a logic/algorithm, a processor, a virtual software or hardware layer, or a combination of the preceding components. In further examples, the simulation device may include instructions executable by a processor. The instructions may cause the simulation device 311 to receive the identified set of coefficients from the search device 310.

Further, as per some examples, responsivity R may be one of the model parameters, and its characteristics may be determined by the simulation device based on corresponding instructions. For example, FIG. 3C illustrates a graph of responsivity R of photodetector as a function of optical power, for various bias voltages (e.g., V_{R}1, V_{R}2, and V_{R}3; V_{R}3>V_{R}2>V_{R}1). The input optical data may be an input optical power Pₒₚₜ. At a higher bias voltage (e.g., V_{R}3) the responsivity R may be non-linear and at a lower bias voltage (e.g., V_{R}1) the responsivity R may be linear or close to linear. In some instances, the characteristics of responsivity R may be determined from at least one of a polynomial, logarithmic, or exponential equation. In further examples, the equation(s) may be integrated into the simulation device 311 to determine the responsivity R. As per one example, a fourth-degree polynomial equation may be used to determine the responsivity R, wherein:

R=(a0)+(a1*Pₒₚₜ)+(a2*Pₒₚₜ²)+(a3*Pₒᵤₜ³)+(a4*Pₒᵤₜ⁴) (1)

The set of coefficients a0, a1, a2, a3, and a4 (as shown in FIG. 2) may be identified from the set of CLTs. The responsivity R, which is a measure of the optical-to-electrical conversion efficiency of a photodetector may be defined from equation (1). In another example, a wavelength, or both wavelength and optical power Pₒₚₜ may be used for determining responsivity. Further, equation (1) may be configured to exhibit linear and non-linear characteristics of responsivity R based on the bias voltage received as an input parameter. Based on the bias voltage V_{R}1/V_{R}2/V_{R}3, the search device 310 selects the set of coefficients. In response to the photodetector behavior model, 300 receiving a higher bias voltage such as V_{R}3, the set of coefficients may be selected such that the responsivity R exhibits non-linear characteristics, as shown in the graph. In some examples, the photodetector behavior model 300 includes a processor that may fetch, decode, and execute instructions stored in a non-transitory machine-readable storage medium. The instructions may cause the photodetector behavior model 300 to determine the responsivity R, as discussed herein. The instructions may also include instructions to perform one or more actions as discussed herein.

Referring back to FIG. 3A, the simulation device 311 determines the characteristics of one or more model parameters. Based on the determined characteristics, the simulation device 311 may determine an output metric, such as output current Iₒₚ. In some examples, output metric current lop may be determined by the following equation:

Iₒₚ=R*Pₒₚₜ (2)

In some examples, the output metric Iₒₚ may be determined by a product of a selected model parameter (e.g., responsivity R), from the determined characteristics of the one or more model parameters, with the input optical data Pₒₚₜ.

Referring back to FIGS. 3A and 3B, in some examples, the level decision code 315, the O/E conversion code 320, and the electrical parasitics code 325 of the simulation device 311 may perform one or more additional actions. For example, the level decision code 315 may obtain the input optical data 335 and, with the determined model parameters, determine a direct current (DC) level for the photodetector under simulation. The O/E conversion code 320 may determine photo-generated carriers of the photodetector based on the DC level, input optical data 335, the reverse bias voltage, and the model parameters. Further, the electrical parasitics code 325 may determine electrical parasitics for photodetector under simulation. Based on the aforementioned actions, the photodetector behavior model 300 outputs the simulated electrical response (e.g., output metric 345 such as electrical current), which is close to an actual response of photodetector.

In some examples, the search device 310 and/or the simulation device 311 may be configured with behavior modeling languages (e.g., Verilog, Very high-speed integrated circuit Hardware Description Language (VHDL), System Verilog, etc.). Further, based on the determined model parameters and the input optical data, the output metric 345 such as output current may be generated and delivered to a receiver front-end circuit (e.g., transimpedance amplifier) (not shown). In further examples, in addition to the set of CLTs, the photodetector behavior model 300 may comprise a set of secondary lookup tables (SLTs) comprising additional model parameters.

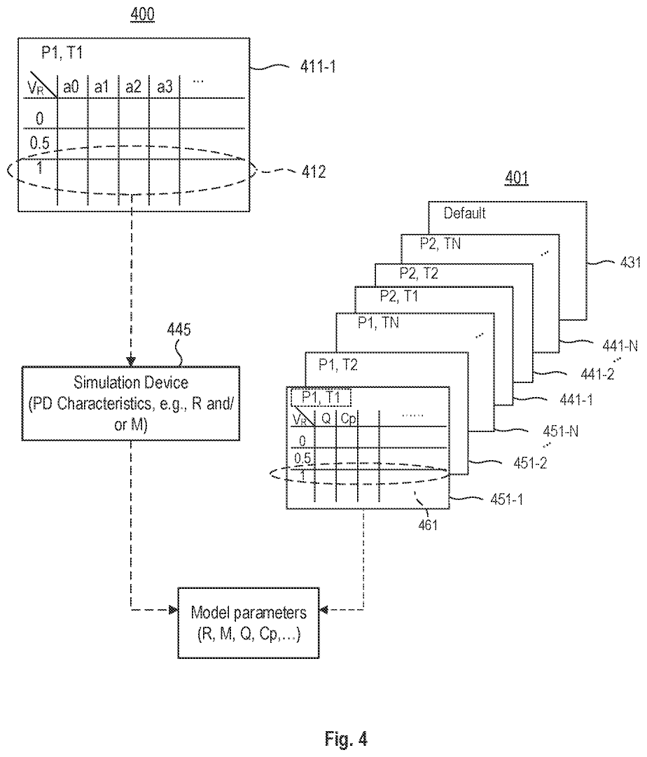

FIG. 4 illustrates an example of a set of CLTs 400 and a set of SLTs 401. As discussed earlier, the set of CLTs 400 may comprise a plurality of lookup tables 411-1 (one table is shown for brevity; Example of FIG. 2 illustrates a set of CLTs 200). The CLTs 400 comprises a plurality of coefficient values corresponding to a plurality of bias voltage. In one example, the set of coefficients are selected to determine model parameters such as responsivity R and/or multiplication factor M.

The model parameters such as responsivity R and multiplication factor M are determined from the input parameters.

Whereas, in further examples, the photodetector behavior model may receive one or more additional model parameters. For example, the additional model parameters may include resonance frequency f₀, Q-factor Q, parasitic capacitance Cₚ, etc. The set of SLTs 401 may comprise the additional model parameters corresponding to various bias voltages, process corners, and temperature conditions. For example, for a given process type (e.g., P1) and a temperature condition (e.g., T1), an SLT 451-1 is provided. The SLT 451-1 may comprise values corresponding to the additional model parameters for various bias voltages V_{R}. In response to a user entering the input parameters, such as process corner and temperature condition, a search device of the photodetector behavior model may select the additional parameters from the set of SLTs.

For example, for a process type P1, and temperature T1, a lookup table 411-1 may be selected from the set of CLTs 400. From the selected CLT 411-1, a set of coefficients 412 may be selected based on a bias voltage received for determining one or more model parameters. Similarly, for the input parameters P1 and T1, a lookup table 451-1 is selected from the set of SLTs 401. From the selected lookup table 451-1, one or more additional model parameters 461 may be directly selected by the search device. The set of coefficients 412 may be further processed by a simulation device 445 (or simulation device 311 of photodetector behavior model 300) to determine the model parameters. Thus, for a given process corner, bias voltage, and temperature condition, the model parameters may be determined from corresponding lookup tables 400, 401. One of ordinary skill in the art would understand that the illustrated lookup tables 400, 401 are discussed herein, merely as examples. Other ways to organize and store model parameters are contemplated. The model parameters stored in the lookup tables may be obtained from simulation of one or more photodetectors or measurement of one or more physical photodetectors.

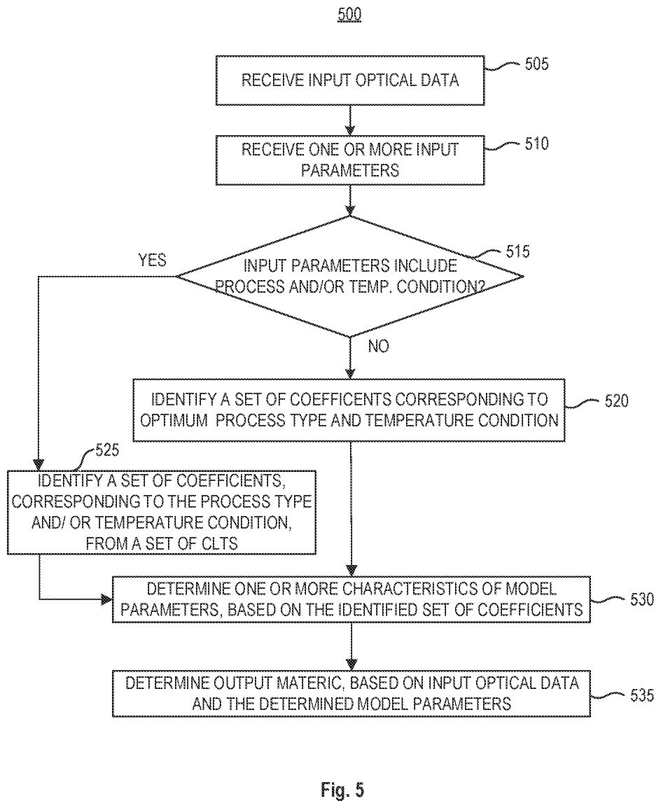

FIG. 5 is an example flow chart illustrating a method 500 of operation of a photodetector behavior model, with a greater level of detail. For example, method 500 may be performed by the photodetector behavior model that includes one or more processors and a storage medium configured with computer-executable instructions for performing the method 500.

At 505, the photodetector behavior model receives input optical data for a photodetector under simulation. In some examples, the input optical data may be a digitized and/or normalized waveform, signal, value, etc. In some instances, the input optical data may be a modulated optical signal.

At 510, the photodetector behavior model receives one or more input parameters that correspond to the PD. The input parameters may include a process corner, a reverse bias voltage, and a temperature condition for the photodetector. In some examples, the user of the photodetector behavior model may be presented with a user interface on a display screen to allow the user to enter the input parameters for the simulation. For example, the user may be required to enter at least a reverse bias voltage considered as mandatory input for the photodetector under simulation. In various examples, the user interface may also allow the user to select and/or enter other input parameters. In further examples, the user interface may include conditions for a process corner of a wafer for the user to select and/or enter. As explained above, including process corner and temperature condition in the simulation may allow a user to verify the reliability of the PD.

At 515, the photodetector behavior model determines whether the user has provided any optional input parameters such as process corner and/or temperature conditions. Based on determining that the user has provided the optional input parameters, at 520, the photodetector behavior model may identify, in a set of coefficient lookup tables (CLTs), a set of coefficients. The set of CLTs may include one or more lookup tables that are organized based on one or more of a process corner, and a temperature condition, such as those shown in FIG. 2 and FIG. 4. In further examples, based on the input parameters such as a process corner and/or temperature condition, the photodetector behavior model may search for and identify additional model parameters from a set of SLTs (example shown in FIG. 4).

In some examples, the photodetector behavior model may take into consideration the process corner and the temperature conditions to select a lookup table and further, select a set of coefficients from the selected lookup table. In some instances, based on the reverse bias voltage, the temperature, the process corner, and the optical power, the photodetector behavior model may automatically search in a lookup table library (e.g., the set of CLTs 400, the set of SLTs 401 of FIG. 4) to determine the model parameters for the photodetector behavior model.

Whereas, at 515, if the photodetector behavior model determines that the user has provided only the bias voltage, then at 525, the photodetector behavior model may identify a set of coefficients corresponding to the bias voltage and corresponding to a standard process type and temperature condition. In some examples, the set of CLTs may include a default CLT provided with coefficients corresponding to optimum conditions. From the default CLT, the set of coefficients may be identified.

At 530, based on the set of coefficients identified, the photodetector behavior model may determine one or more model parameters for the photodetector. In further examples, additional model parameters may be searched and identified from a secondary lookup table. For example, the photodetector behavior model provides the model parameters to the photodetector behavior model to enable the photodetector behavior model to simulate an electrical response for the photodetector. In some examples, the photodetector behavior model may include a level decision code/algorithm, an O/E conversion part/algorithm, and an electrical parasitics code/algorithm. The photodetector behavior model may be configured to provide appropriate model parameters for each of those parts. In some examples, the level decision code may be configured to obtain an input waveform and determine a DC level for the photodetector under simulation. The optical-electrical conversion part may be configured to determine photo-generated carriers of the photodetector based on the DC level, input optical power, the reverse bias voltage, and the model parameters. The electrical parasitics code may be configured to determine electrical parasitics for the photodetector.

At 535, based on the optical power and the determined model parameters, the photodetector behavior model may provide output metric data (e.g., electrical signals such as current). The output metric data may be indicative of the electrical response of the photodetector receiving the input optical data.

The disclosed techniques may be implemented in a SiPh PDK that provides accurate and intuitive behavioral models with a user-friendly interface. The techniques are advantageous over existing SiPh PDK because the disclosed photodetector behavior model simulates various characteristics that are close to the real-time behavior of photodetectors.

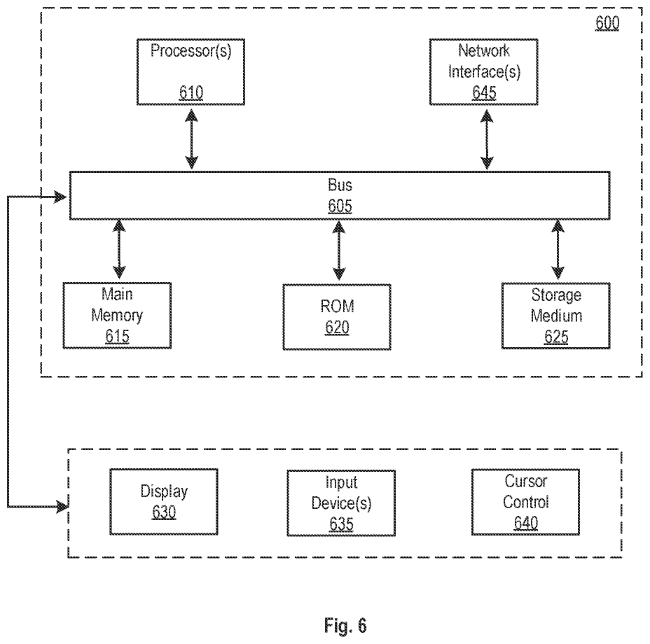

FIG. 6 depicts a schematic block diagram of an example photodetector behavior model 600 in which various of the examples described herein may be implemented. In some examples, the photodetector behavior model 600 may be a sub-system of a photodetector behavior model. Further, the photodetector behavior model includes a bus 605 or other communication mechanisms for communicating information, one or more hardware processor(s) 610 coupled with bus 605 for processing information. The hardware processor(s) 610 (hereinafter, referred to as ‘processors’ for brevity) may be, for example, one or more general-purpose microprocessors.

The photodetector behavior model 600 also includes a main memory 615, such as random-access memory (RAM), cache, and/or other dynamic storage mediums, coupled to the bus 605 for storing information and instructions to be executed by the processor 610. The main memory 615 also may be used for storing temporary variables or other intermediate information during the execution of instructions to be executed by processor 610.

The photodetector behavior model 600 further includes a read-only memory (ROM) 620 or other static storage medium coupled to bus 605 for storing static information and instructions for processor 610. A storage medium 625, such as a magnetic disk, optical disk, or Universal Serial Bus (USB) thumb drive (Flash drive), etc., is provided and coupled to bus 605 for storing information and instructions. For example, the various instructions corresponding to methods 350 and 500 may be stored at one or more of the main memory 615, the ROM 620, and the storage medium 625. In further examples, the storage medium may be a non-transitory type. The lookup tables 200, 400, and 401 may also be stored in one or more of the main memory 615, the ROM 620, and the storage medium 625t. The processor 610 may fetch, decode, and execute the instructions stored at the main memory 615, the ROM 620, and the storage medium 625 to perform the techniques disclosed herein.

The photodetector behavior model 600 may be coupled via bus 605 to a display 630, such as a liquid crystal display (LCD) (or touch screen), for displaying information (e.g., a user interface) to a computer user. An input device 635, including alphanumeric and other keys, may be coupled to bus 605 for communicating information and command selections to processor 610. Another type of user input device is cursor control 640, such as a mouse, a trackball, or cursor direction keys for communicating direction information and command selections to processor 610 and for controlling cursor movement on display 630.

In some examples, the same direction information and command selections as cursor control may be implemented via receiving touches on a touch screen without a cursor.

This and other modules may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables.

In general, the terms “model,” “system,” “device,” “apparatus,” “database,” data store,” and the like, as used herein, may refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Per, or Python. It will be appreciated that software components may be callable from other components or themselves, and/or may be invoked in response to detected events or interrupts. Software components configured for execution on computing devices may be provided on a computer-readable medium, such as a compact disc, digital video disc, flash drive, magnetic disc, or any other tangible medium, or as a digital download (and may be originally stored in a compressed or installable format that requires installation, decompression or decryption before execution). Such software code may be stored, partially or fully, on a memory device of the executing computing device, for execution by the computing device. Software instructions may be embedded in firmware, such as an Erasable Programmable Read-Only Memory (EPROM). It will be further appreciated that hardware components may be comprised of connected logic units, such as gates and flip-flops, and/or maybe comprised of programmable units, such as programmable gate arrays or processors.

The photodetector behavior model 600 may implement the techniques described herein using customized hard-wired logic, one or more Application Specific Integrated Circuits (ASICs) or Field Programmable Gate Arrays (FPGAs), firmware, and/or program logic which in combination with the computer system causes or programs photodetector behavior model 600 to be a special-purpose machine. According to some examples, the techniques herein are performed by photodetector behavior model 600 in response to processor(s) 610 executing one or more sequences of one or more instructions contained in main memory 615.

Such instructions may be read into main memory 615 from another storage medium, such as storage medium 625. Execution of the sequences of instructions contained in main memory 615 causes processor(s) 610 to perform the process type steps described herein. In alternative examples, hard-wired circuitry may be used in place of or in combination with software instructions.

The photodetector behavior model 600 also includes a communication/network interface 645 coupled to bus 605. The network interface 645 provides two-way data communication on one or more networks. The photodetector behavior model 600 may send messages and receive data, including program code, through the network(s), network link, and the network interface 645. In the Internet example, a server might transmit a requested code for an application program through the Internet, the Internet Service Provider (ISP), the local network, and the network interface 645. The received code may be executed by processor 610 as it is received, and/or stored in storage medium 625, or other non-volatile storage for later execution.

Each of the processes, methods and algorithms described in the preceding sections may be embodied in, and fully or partially automated by, code components executed by one or more computer systems or computer processors comprising computer hardware. One or more computer systems or computer processors may also operate to support the performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process type blocks may be omitted in some implementations. The methods and processes described herein are also not limited to any particular sequence, and the blocks or states relating thereto may be performed in other sequences that are appropriate or may be performed in parallel, or some other manner. Blocks or states may be added to or removed from the disclosed example examples. The performance of certain operations or processes may be distributed among computer systems or computer processors, not only residing within a single machine but deployed across several machines.

As used herein, a circuit might be implemented utilizing any form of hardware, software, or a combination thereof. For example, one or more processors, controllers, ASICs, Programmable Logic Arrays (PLAs), Programmable Array Logics (PALs), Complex Programmable Logic Device (CPLDs), FPGAs, logical components, software routines, or other mechanisms might be implemented to make up a circuit. In some examples, the various circuits described herein might be implemented as discrete circuits or the functions and features described may be shared in part or total among one or more circuits. Even though various features or parts of functionality may be individually described or claimed as separate circuits, these features and functionality may be shared among one or more common circuits, and such description shall not require or imply that separate circuits are required to implement such features or functionality. Where a circuit is implemented in whole or in part using software, such software may be implemented to operate with a computing or processing system capable of carrying out the functionality described with respect thereto, such as photodetector behavior model 600.

The model/apparatus 100, 300, 600 may include hardware and/or combinations of hardware and programming to perform functions provided herein. The terms—converter part or comparator part includes a circuit, module, and/or combination of circuit/modules and software. While certain examples have been shown and described above, various changes in form and details may be made. Certain features that have been described in relation to one example and/or method may be related to other examples. In other words, flow diagrams, methods, features, components, and/or properties described in relation to one example may be useful in other examples. Furthermore, it should be appreciated that the systems and methods described herein may include various combinations and/or sub-combinations of the components and/or features of the different examples described. Thus, features described with reference to one or more examples can be combined with other examples described herein.

We claim:

1. A method comprising:
receiving, by a photodetector behavior model, an input optical data;
receiving, by the photodetector behavior model, input values corresponding to one or more input parameters for a photodetector;
identifying, by the photodetector behavior model, a set of coefficients from a set of coefficient lookup tables, based on the input values corresponding to the one or more input parameters;
determining, by the photodetector behavior model, characteristics of one or more model parameters of the photodetector based on the identified set of coefficients; and
determining, by the photodetector behavior model, an output metric indicative of an electrical response of the photodetector, based on the input optical data and the determined characteristics of the one or more model parameters.

2. The method of claim 1, wherein the one or more input parameters includes at least one of a reverse bias voltage, a process corner, and a temperature condition.

3. The method of claim 2, wherein the reverse bias voltage is categorized as a mandatory input, and wherein the process corner and the temperature condition are categorized as optional inputs.

4. The method of claim 3, wherein each coefficient lookup table, out of the set of coefficient lookup tables, includes coefficients corresponding to a plurality of bias voltages ranging up to an avalanche breakdown voltage of the photodetector, and the plurality of bias voltages are provided in a random order, a random progressive order, a stepped progressive order, or a combination of one or more thereof.

5. The method of claim 1, wherein the one or more model parameters includes a responsivity and a multiplication factor of the photodetector.

6. The method of claim 1, wherein determining, by the photodetector behavior model, the characteristics of one or more model parameters of the photodetector, comprises:
selecting, by the photodetector behavior model, one or more equations from a set of equations, based on the input values corresponding to the one or more inputs parameters; and
determining, by the photodetector behavior model, the characteristics of one or more model parameters from the one or more equations selected.

7. The method of claim 1, further comprises:
identifying, by the photodetector behavior model, one or more additional parameters from a set of secondary lookup tables, based on the input values corresponding to the one or more input parameters.

8. The method of claim 7, wherein the one or more additional parameters includes a resonance frequency, a Q-factor, and a parasitic resistance/capacitance/inductance.

9. The method of claim 1, wherein the set of coefficient lookup tables are obtained by simulation of one or more photodetectors or measurement of characteristics of one or more physical photodetectors.

10. The method of claim 1, wherein the set of coefficient lookup tables includes one or more coefficient lookup tables, and each coefficient look table corresponding to a selected process corner and a selected temperature conditions.

11. The method of claim 10, wherein each coefficient look table comprises a plurality of sets of coefficients, wherein each set of coefficients corresponds to a selected reverse bias voltage.

12. An apparatus, comprising:
one or more processors; and
a storage medium storing instructions executable by the one or more processors to cause the one or more processors to:
receive an input optical data;
receive input values corresponding to one or more input parameters for a photodetector;
identify a set of coefficients from a set of coefficient lookup tables, based on the input values corresponding to the one or more input parameters;
determine characteristics of one or more model parameters of the photodetector based on the identified set of coefficients; and
determine an output metric indicative of an electrical response of the photodetector, based on the input optical data and the determined characteristics of the one or more model parameters.

13. The apparatus of claim 12, wherein identification of the set of coefficients from the set of coefficient lookup tables, includes the one or more processors to:
select a coefficient lookup table from the set of coefficient lookup tables, based on the one or more input parameters; and
identify the set of coefficients from the selected coefficient lookup table, based on a reverse bias voltage, wherein the reverse bias voltage is categorized as a mandatory input parameter out of the one or more input parameters.

14. The apparatus of claim 13, wherein the set of coefficient lookup tables include a default coefficient lookup table, wherein identification of the set of coefficients from the set of coefficient lookup tables, further includes the one or more processors to:
select the default coefficient lookup table from the set of coefficient lookup tables based on availability of only the mandatory input parameter.

15. The apparatus of claim 12, wherein the set of coefficient lookup tables are stored on at least one of the storage medium or a storage disk, wherein the storage disk is disposed within the apparatus of the apparatus or disposed external to the apparatus.

16. The apparatus of claim 12, wherein the characteristics of the one or more model parameters includes one of a linear or a non-linear characteristics.

17. A non-transitory machine-readable storage medium comprising instructions, the instructions executable by a processor of a device to:
receive an input optical data;
receive input values corresponding to one or more input parameters for a photodetector;
identify a set of coefficients from a set of coefficient lookup tables, based on the input values corresponding to the one or more input parameters;
determine characteristics of one or more model parameters of the photodetector based on the identified set of coefficients; and
determine an output metric indicative of an electrical response of the photodetector, based on the input optical data and the determined characteristics of the one or more model parameters.

18. The non-transitory storage medium of claim 17, wherein the instructions to determine the characteristics of the one or more model parameters, includes instructions to:
select an equation from a set of equations, based on the input values corresponding to the one or more inputs parameters; and
determine the characteristics of one or more model parameters from the one or more equations selected.

19. The non-transitory storage medium of claim 18, wherein the set of equations includes at least one of a polynomial equation, a logarithmic equation, or an exponential equation.

20. The non-transitory storage medium of claim 17, wherein the instructions to determine the output metric indicative of an electrical response of the photodetector, includes instructions to:
determine the output metric by multiplication of a selected model parameter, from the determined characteristics of the one or more model parameters, with the input optical data.
